(19) United States
(12) Patent Application Publication
(10) Pub. No.: US 2012/0292132 A1
(43) Pub. Date: Nov. 22, 2012

(54) Scaffold, releasable support and method

(76) Inventor: Gary Lovas, Apollo, PA (US)

(21) Appl. No.: 13/068,799

(22) Filed: May 20, 2011

(51) Int. Cl. E04G 1/20; B23P 11/00

(52) U.S. Cl. 182/223; 29/428

(57) ABSTRACT

A scaffold including a right end frame access ladder having a right rail and a left rail in spaced relation with the right rail, and a plurality of horizontals attached to the right rail and the left rail. The scaffold includes a left end frame access ladder having a right rail and a left rail in spaced relation with the right rail, and a plurality of horizontals attached to the right rail and left rail. The scaffold includes a first adjustable platform support truss attached to the right end frame access ladder and the second end frame access ladder. The scaffold includes a second adjustable platform support truss attached to the right end frame access ladder and the second end frame access ladder and essentially in parallel and spaced relation with the first adjustable platform support truss. The scaffold includes a removable support having a first bracket, a second bracket and a center portion connected to the first and second brackets. A removable support. A method for using a scaffold having a removable support.

### FIELD OF THE INVENTION

The present invention is related to a removable support for an original Perry scaffold or similar scaffold to prevent the scaffold platform from failing and workers from falling through the platform and injuring themselves. (As used herein, references to the “present invention” or “invention” relate to exemplary embodiments and not necessarily to every embodiment encompassed by the appended claims.) More specifically, the present invention is related to a removable support for a original Perry scaffold or similar scaffold having a first bracket and a second bracket and a center portion attached to the first and second brackets that are placed on the scaffold and under the platform to prevent the scaffold platform from failing and workers from falling through the platforms and injuring themselves.

### BACKGROUND OF THE INVENTION

This section is intended to introduce the reader to various aspects of the art that may be related to various aspects of the present invention. The following discussion is intended to provide information to facilitate a better understanding of the present invention. Accordingly, it should be understood that statements in the following discussion are to be read in this light, and not as admissions of prior art.

Perry style scaffolding is used to perform all types of construction. This includes:

Installing suspended ceilings

Framing

Installing and finishing dry wall

Painting

Wall paper installation

Plus many more

These scaffolds are easy to set up and platform heights are easily adjustable. These types of scaffolds can be stacked up to three units high. Also, these scaffolds are great for working on stairs while maintaining a level platform.

The wood platforms of these scaffolds, as they age, are susceptible for workers standing on them to fall through the scaffold resulting in serious injuries to workers standing on these scaffold platforms when they fall to the ground.

Most commercial construction companies own hundreds of these original Perry scaffolds or similar scaffolds. Over time and over many usages these scaffold platforms weaken. Note the platforms usually consist of ⅝″ to ¾″ thick plywood surrounded with protective steel banding around the plywood. These platforms seem very strong when new but there are instances where brand new platforms bow and fall through the scaffold trusses; although usually the platforms that bow are the older ones that have seen many usages.

The most common injuries to workers when the platforms fail are broken ankles and scrapes and cuts to the worker when they fall to the ground. This problem can be eliminated with the metal safety brackets in use with the safety straps (interior use) or steel cable\metal plate (exterior use) of the present invention.

### BRIEF SUMMARY OF THE INVENTION

The present invention pertains to a scaffold. The scaffold comprises a right end frame access ladder having a right rail and a left rail in spaced relation with the right rail, and a plurality of horizontals attached to the right rail and the left rail. The scaffold comprises a left end frame access ladder having a right rail and a left rail in spaced relation with the right rail, and a plurality of horizontals attached to the right rail and left rail. The scaffold comprises a first adjustable platform support truss attached to the right end frame access ladder and the second end frame access ladder.

The scaffold comprises a second adjustable platform support truss attached to the right end frame access ladder and the second end frame access ladder and essentially in parallel and spaced relation with the first adjustable platform support truss. The first and second adjustable platform support trusses each having a horizontal portion, and upward portion connected at about a right angle to the horizontal portion and extending upward from the horizontal portion, and a downward portion connected at about a right angle with the horizontal portion and extending downward from the horizontal portion. The upward portion and the horizontal portion and the downward portion together have essentially a cross sectional shape of a Z with a surface having a Z shape.

The scaffold comprises a removable support having a first bracket, a second bracket and a center portion connected to the first and second brackets. The first bracket removably connected with the first platform support truss having a shape that conforms with the Z shape of the surface. The first bracket having a horizontal portion that is disposed on and alongside the horizontal portion of the first platform support truss, a downward portion connected at about a right angle to and extending down from the horizontal portion of the first bracket and disposed alongside and adjacent with the downward portion of the first platform support truss and connected to the center portion, and a hooking portion connected to the horizontal portion of the first bracket that wraps about the upward portion of the first platform support truss.

The second bracket having a horizontal portion that is disposed on and alongside the horizontal portion of the second platform support truss, a downward portion connected at about a right angle to and extending down from the horizontal portion of the second bracket and disposed alongside and adjacent with the downward portion of the second platform support truss and connected to the center portion, and a hooking portion connected to the horizontal portion of the second bracket that wraps about the upward portion of the second platform support truss.

The present invention pertains to a removable support for a scaffold, the scaffold having a right end frame access ladder having a right rail and a left rail in spaced relation with the right rail, and a plurality of horizontals attached to the right rail and the left rail; a left end frame access ladder having a right rail and a left rail in spaced relation with the right rail, and a plurality of horizontals attached to the right rail and left rail; a first adjustable platform support truss attached to the right end frame access ladder and the second end frame access ladder; and a second adjustable platform support truss attached to the right end frame access ladder and the second end frame access ladder and essentially in parallel and spaced relation with the first adjustable platform support truss, the first and second adjustable platform support trusses each having a horizontal portion, and upward portion connected at about a right angle to the horizontal portion and extending upward from the horizontal portion, and a downward portion connected at about a right angle with the horizontal portion and extending downward from the horizontal portion, the upward portion and the horizontal portion and the downward portion together having essentially a cross sectional shape of a Z with a surface having a Z shape; and a platform disposed on the first and second support truss upon which a user stands.

The removable support comprises a first bracket. The removable support comprises a second bracket. The removable support comprises a center portion connected to the first and second brackets. The first bracket removably connected with the first platform support truss having a shape that conforms with the Z shape of the surface. The first bracket having a horizontal portion that is disposed on and alongside the horizontal portion of the first platform support truss, a downward portion connected at about a right angle to and extending down from the horizontal portion of the first bracket and disposed alongside and adjacent with the downward portion of the first platform support truss and connected to the center portion, and a hooking portion connected to the horizontal portion of the first bracket that wraps about the upward portion of the first platform support truss.

The second bracket having a horizontal portion that is disposed on and alongside the horizontal portion of the second platform support truss, a downward portion connected at about a right angle to and extending down from the horizontal portion of the second bracket and disposed alongside and adjacent with the downward portion of the second platform support truss and connected to the center portion, and a hooking portion connected to the horizontal portion of the second bracket that wraps about the upward portion of the second platform support truss.

The present invention pertains to a method for using a scaffold. The method comprises the steps of removably connecting a first bracket of a removable support with a first adjustable platform support truss of the scaffold, the first adjustable platform support truss has a horizontal portion, an upward portion connected at about a right angle to the horizontal portion and extending upward from the horizontal portion, and a downward portion connected at about a right angle with the horizontal portion and extending downward from the horizontal portion, the upward portion and the horizontal portion and the downward portion together having essentially a cross sectional shape of a Z with a surface having a Z shape, the first bracket having a shape that conforms with the Z shape of the surface. The first bracket having a horizontal portion that is disposed on and alongside the horizontal portion of the first platform support truss, a downward portion connected at about a right angle to and extending down from the horizontal portion of the first bracket and disposed alongside and adjacent with the downward portion of the first platform support truss and connected to the center portion, and a hooking portion connected to the horizontal portion of the first bracket that wraps about the upward portion of the first platform support truss. The hooking portion has a first leg connected to the horizontal portion of the first bracket at about a right angle disposed alongside and aligned with the upward portion of the first platform support truss, a middle leg connected to the first leg at about a right angle and disposed over the upward portion of the first platform support truss, and a second leg connected to the middle leg at about a right angle and disposed alongside and aligned with the upward portion of the first platform support truss.

There is the step of removably connecting a second bracket of the removable support with a second adjustable platform support truss of the scaffold, the second adjustable platform support truss has a horizontal portion, an upward portion connected at about a right angle to the horizontal portion of the second adjustable platform support truss and extending upward from the horizontal portion of the second adjustable platform support truss, and a downward portion connected at about a right angle with the horizontal portion of the second adjustable platform support truss and extending downward from the horizontal portion of the second adjustable platform support truss, the upward portion and the horizontal portion and the downward portion of the second adjustable platform support truss together having essentially a cross sectional shape of a Z with a surface having a Z shape. The second bracket having a horizontal portion that is disposed on and alongside the horizontal portion of the second platform support truss, a downward portion connected at about a right angle to and extending down from the horizontal portion of the second bracket and disposed alongside and adjacent with the downward portion of the second platform support truss and connected to the center portion, and a hooking portion connected to the horizontal portion of the second bracket that wraps about the upward portion of the second platform support truss. The hooking portion of the second bracket has a first leg connecting to the horizontal portion of the second bracket at about a right angle disposed alongside and aligned with the upward portion of the second platform support truss, a middle leg connected to the first leg of the second bracket at about a right angle and disposed over the upward portion of the second platform support truss, and a second leg connected to the middle leg of the second bracket at about a right angle and disposed alongside and aligned with the upward portion of the second platform support truss. There is the step of placing a platform upon which a user stands on the first and second support trusses and first and second brackets and over a center portion of the removable support that is attached to and connects the first and second brackets, the first adjustable platform support truss attached to a right end frame access ladder and a second end frame access ladder of the scaffold; the second adjustable platform support truss attached to the right end frame access ladder and the second end frame access ladder and essentially in parallel and spaced relation with the first adjustable platform support truss.

During the erection of a typical original Perry scaffold or similar scaffold, a worker would install the removable support with the safety brackets with strap (interior) or cable (exterior) of the present invention prior to setting the platform in place. Then once the platform in installed over the removable support it will be essentially impossible for the platform to fall through the scaffolding trusses. The present invention will prevent many injuries in the construction work place also saving the construction companies money with lower insurance premiums and saving the insurance companies money by eliminating accidents.

The brackets of the present invention are designed to fit essentially perfectly with the trusses of a typical original Perry scaffold or similar scaffold.

### BRIEF DESCRIPTION OF THE SEVERAL VIEWS OF THE DRAWING

In the accompanying drawings, the preferred embodiment of the invention and preferred methods of practicing the invention are illustrated in which:

FIG. 1 is a perspective view of a scaffold of the present invention.

FIG. 2 is a cross-sectional view of the scaffold of the present invention showing the removable support.

FIG. 3 is a perspective view of one embodiment of a bracket of the present invention.

FIG. 4 is a perspective view of another embodiment of a removable support of the present invention.

FIG. 5 is a cross-sectional view of the scaffold of the present invention showing another embodiment of the removable support.

FIG. 6 shows an alternative design of the hooking portion.

### DETAILED DESCRIPTION OF THE INVENTION

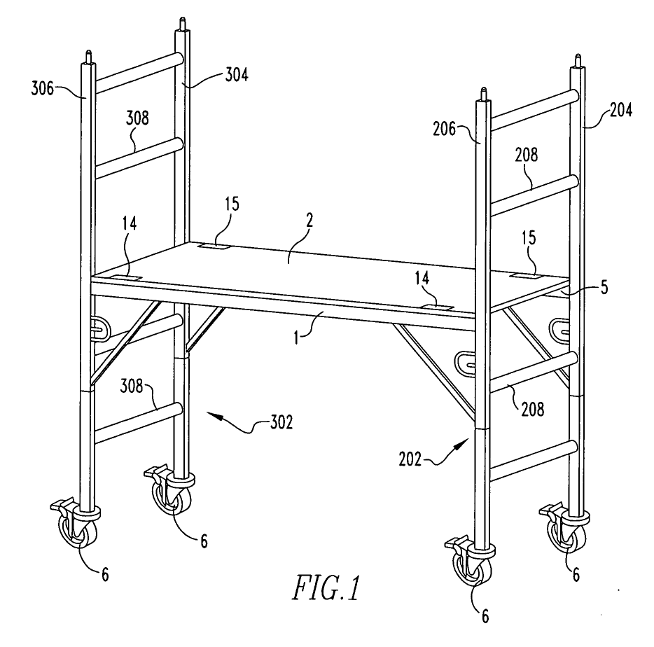

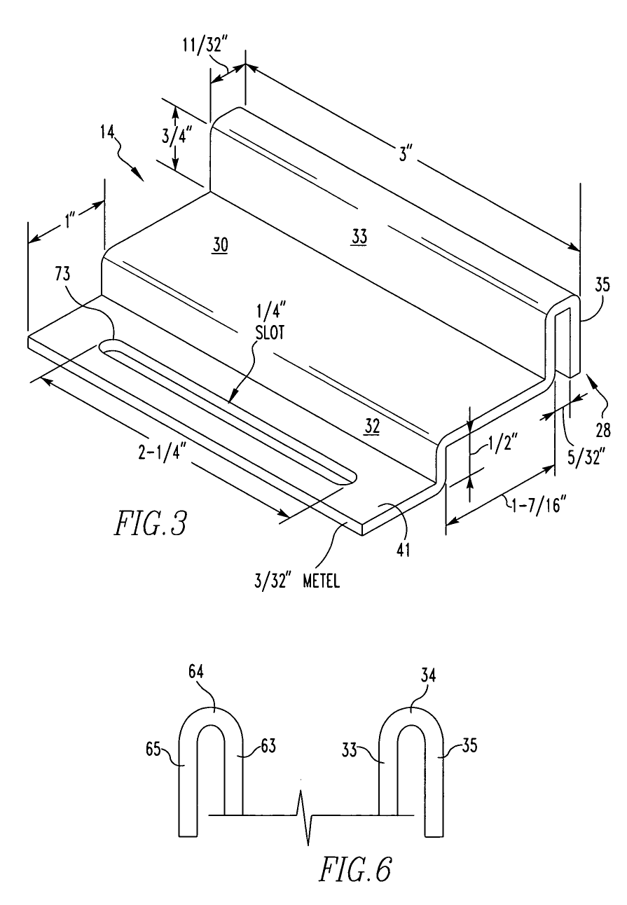

Referring now to the drawings wherein like reference numerals refer to similar or identical parts throughout the several views, and more specifically to FIGS. 1-5 thereof, there is shown a scaffold 200. The scaffold 200 comprises a right end frame access ladder 202 having a right rail 204 and a left rail 206 in spaced relation with the right rail 204, and a plurality of horizontals 208 attached to the right rail 204 and the left rail 208. The scaffold 200 comprises a left end frame access ladder 302 having a right rail 304 and a left rail 306 in spaced relation with the right rail 304, and a plurality of horizontals 308 attached to the right rail 304 and left rail 306. The scaffold 200 comprises a first adjustable platform support truss 1 attached to the right end frame access ladder 202 and the second end frame access ladder 302. There may be casters 6 disposed at the base of the rails on which the scaffold 200 rolls.

The scaffold 200 comprises a second adjustable platform support truss 5 attached to the right end frame access ladder 202 and the second end frame access ladder 302 and essentially in parallel and spaced relation with the first adjustable platform support truss 1. The first and second adjustable platform support trusses each having a horizontal portion, and upward portion connected at about a right angle to the horizontal portion and extending upward from the horizontal portion, and a downward portion connected at about a right angle with the horizontal portion and extending downward from the horizontal portion. The upward portion and the horizontal portion and the downward portion together have essentially a cross sectional shape of a Z with a surface having a Z shape.

The scaffold 200 comprises a removable support 100 having a first bracket 14, a second bracket 15 and a center portion 20 connected to the first and second brackets. The first bracket 14 removably connected with the first platform support truss 1 having a shape that conforms with the Z shape of the surface 37. The first bracket 14 having a horizontal portion 30 that is disposed on and alongside the horizontal portion 24 of the first platform support truss 1, a downward portion 32 connected at about a right angle to and extending down from the horizontal portion 30 of the first bracket 1 and disposed alongside and adjacent with the downward portion 26 of the first platform support truss 1 and connected to the center portion 20, and a hooking portion 28 connected to the horizontal portion 30 of the first bracket 14 that wraps about the upward portion 22 of the first platform support truss 1.

The second bracket 15 having a horizontal portion 60 that is disposed on and alongside the horizontal portion 54 of the second platform support truss 5, a downward portion 62 connected at about a right angle to and extending down from the horizontal portion 54 of the second bracket 15 and disposed alongside and adjacent with the downward portion 56 of the second platform support truss 5 and connected to the center portion 20, and a hooking portion 58 connected to the horizontal portion 60 of the second bracket 15 that wraps about the upward portion 52 of the second platform support truss 5. The scaffold 200 comprises a platform 2 disposed on the first and second support trusses and first and second brackets upon which a user stands.

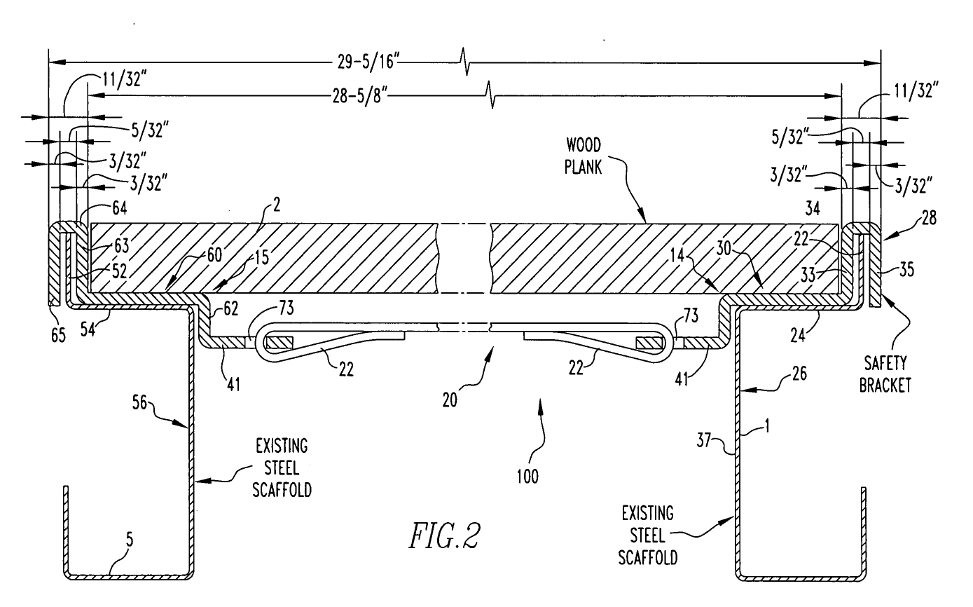

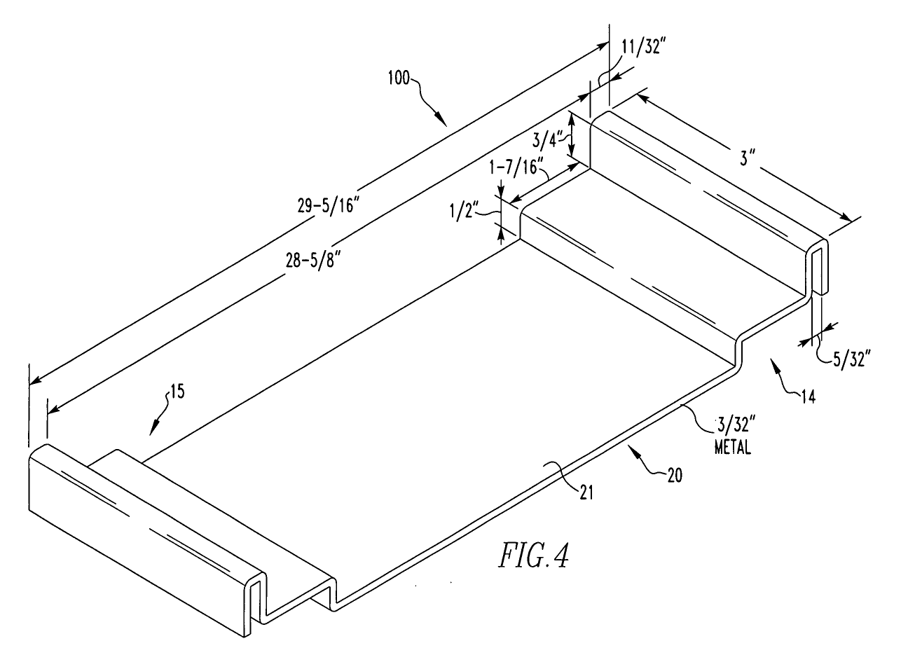

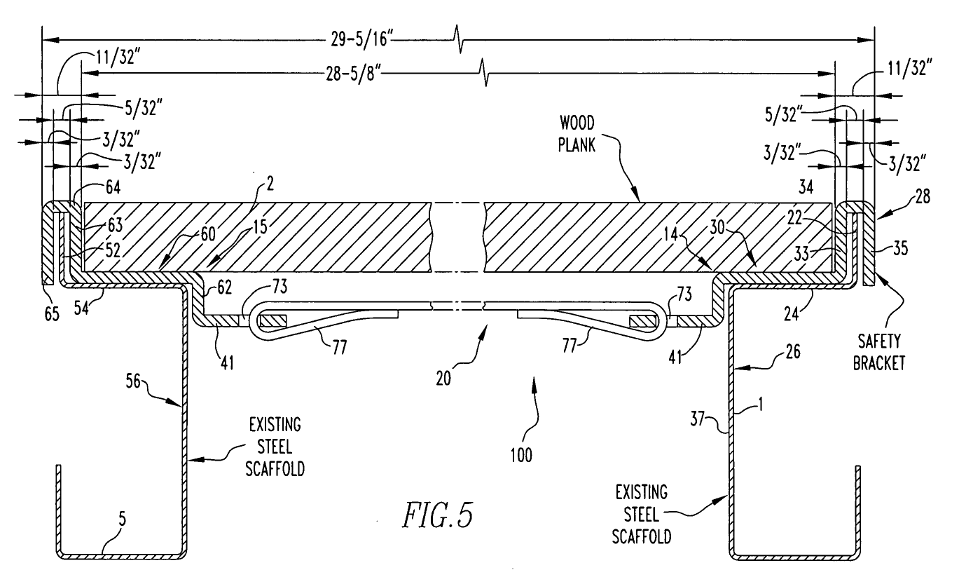

The center portion 20 may be a metal plate 21, as shown in FIG. 4. Alternatively, as shown in FIGS. 2 and 5, the first bracket 14 and the second bracket 15 each have a tab 41 connected to the downward portion and extending from the downward portion inwards away from the upwards portion, and the center portion 20 includes an adjustable strap 22 or metal cable 77, as shown in FIGS. 2 and 5, respectively, attached to the tab 41 of the first bracket 14 and to the tab 41 of the second bracket 15.

The hooking portion 28 may have a first leg 33 connected to the horizontal portion 30 of the first bracket 14 at about a right angle disposed alongside and aligned with the upward portion 22 of the first platform support truss 1, a middle leg 34 connected to the first leg 33 at about a right angle and disposed over the upward portion 22 of the first platform support truss 1, and a second leg 35 connected to the middle leg 34 at about a right angle and disposed alongside and aligned with the upward portion 22 of the first platform support truss 1. The hooking portion 58 of the second bracket 15 has a first leg 63 connecting to the horizontal portion 60 of the second bracket 15 at about a right angle disposed alongside and aligned with the upward portion 52 of the second platform support truss 5, a middle leg 64 connected to the first leg 63 of the second bracket 15 at about a right angle and disposed over the upward portion 52 of the second platform support truss 5, and a second leg 65 connected to the middle leg 64 of the second bracket 15 at about a right angle and disposed alongside and aligned with the upward portion 52 of the second platform support truss 5. Alternatively, as shown in FIG. 6, each hooking portion 28, 58 may have a rounded middle leg, formed by bending the metal.

The present invention pertains to a removable support 100 for a scaffold 200 as shown in FIGS. 2-4. The scaffold 200 comprises a right end frame access ladder 202 having a right rail 204 and a left rail 206 in spaced relation with the right rail 204, and a plurality of horizontals 208 attached to the right rail 204 and the left rail 208. The scaffold 200 comprises a left end frame access ladder 302 having a right rail 304 and a left rail 306 in spaced relation with the right rail 304, and a plurality of horizontals 308 attached to the right rail 304 and left rail 306. The scaffold 200 comprises a first adjustable platform support truss 1 attached to the right end frame access ladder 202 and the second end frame access ladder 302. The scaffold 200 comprises a second adjustable platform support truss 5 attached to the right end frame access ladder 202 and the second end frame access ladder 302 and essentially in parallel and spaced relation with the first adjustable platform support truss 1. The first and second adjustable platform support trusses each having a horizontal portion, and upward portion connected at about a right angle to the horizontal portion and extending upward from the horizontal portion, and a downward portion connected at about a right angle with the horizontal portion and extending downward from the horizontal portion, the upward portion and the horizontal portion and the downward portion together having essentially a cross sectional shape of a Z with a surface having a Z shape. The scaffold 200 comprises a platform 2 disposed on the first and second support trusses upon which a user stands.

The removable support 100 comprises a first bracket 14. The removable support 100 comprises a second bracket 15. The removable support 100 comprises a center portion 20 connected to the first and second brackets. The first bracket 14 removably connected with the first platform support truss 1 having a shape that conforms with the Z shape of the surface 37. The first bracket 14 having a horizontal portion 30 that is disposed on and alongside the horizontal portion 24 of the first platform support truss 1, a downward portion 32 connected at about a right angle to and extending down from the horizontal portion 30 of the first bracket 1 and disposed alongside and adjacent with the downward portion 26 of the first platform support truss 1 and connected to the center portion 20, and a hooking portion 28 connected to the horizontal portion 30 of the first bracket 14 that wraps about the upward portion 22 of the first platform support truss 1.

The second bracket 15 having a horizontal portion 60 that is disposed on and alongside the horizontal portion 54 of the second platform support truss 5, a downward portion 62 connected at about a right angle to and extending down from the horizontal portion 54 of the second bracket 15 and disposed alongside and adjacent with the downward portion 56 of the second platform support truss 5 and connected to the center portion 20, and a hooking portion 58 connected to the horizontal portion 60 of the second bracket 15 that wraps about the upward portion 52 of the second platform support truss 5.

The center portion 20 may be a metal plate 21, as shown in FIG. 4. Alternatively, as shown in FIGS. 2 and 5, the first bracket 14 and the second bracket 15 each have a tab 41 connected to the downward portion and extending from the downward portion inwards away from the upwards portion, and the center portion 20 includes an adjustable strap 22 or metal cable 77, as shown in FIGS. 2 and 5, respectively, attached to the tab 41 of the first bracket 14 and to the tab 41 of the second bracket 15.

The hooking portion 28 may have a first leg 33 connected to the horizontal portion 30 of the first bracket 14 at about a right angle disposed alongside and aligned with the upward portion 22 of the first platform support truss 1, a middle leg 34 connected to the first leg 33 at about a right angle and disposed over the upward portion 22 of the first platform support truss 1, and a second leg 35 connected to the middle leg 34 at about a right angle and disposed alongside and aligned with the upward portion 22 of the first platform support truss 1. The hooking portion 58 of the second bracket 15 has a first leg 63 connecting to the horizontal portion 60 of the second bracket 15 at about a right angle disposed alongside and aligned with the upward portion 52 of the second platform support truss 5, a middle leg 64 connected to the first leg 63 of the second bracket 15 at about a right angle and disposed over the upward portion 52 of the second platform support truss 5, and a second leg 65 connected to the middle leg 64 of the second bracket 15 at about a right angle and disposed alongside and aligned with the upward portion 52 of the second platform support truss 5. Alternatively, as shown in FIG. 6, each hooking portion 28, 58 may have a rounded middle leg.

The present invention pertains to a method for using a scaffold 200. The method comprises the steps of removably connecting a first bracket 14 of a removable support 100 with a first adjustable platform support truss 1 of the scaffold 200. The first adjustable platform support truss 1 has a horizontal portion 24, an upward portion 22 connected at about a right angle to the horizontal portion 24 and extending upward from the horizontal portion 24, and a downward portion 26 connected at about a right angle with the horizontal portion 24 and extending downward from the horizontal portion 24. The upward portion 22 and the horizontal portion 24 and the downward portion 26 together have essentially a cross sectional shape of a Z with a surface having a Z shape. The first bracket 14 has a shape that conforms with the Z shape of the surface 37. The first bracket 14 has a horizontal portion 30 that is disposed on and alongside the horizontal portion 24 of the first platform support truss 1, a downward portion 32 connected at about a right angle to and extending down from the horizontal portion 30 of the first bracket 1 and disposed alongside and adjacent with the downward portion 26 of the first platform support truss 1 and connected to the center portion 20, and a hooking portion 28 connected to the horizontal portion 30 of the first bracket 14 that wraps about the upward portion 22 of the first platform support truss 1.

There is the step of removably connecting a second bracket 15 of the removable support 100 with a second adjustable platform support truss 5 of the scaffold 200. The second adjustable platform support truss 5 has a horizontal portion 54, an upward portion 52 connected at about a right angle to the horizontal portion 54 of the second adjustable platform support truss 5 and extending upward from the horizontal portion 54 of the second adjustable platform support truss 5, and a downward portion 56 connected at about a right angle with the horizontal portion 54 of the second adjustable platform support truss 5 and extending downward from the horizontal portion 54 of the second adjustable platform support truss 5. The upward portion 52 and the horizontal portion 54 and the downward portion 56 of the second adjustable platform support truss 5 together having essentially a cross sectional shape of a Z with a surface having a Z shape. The second bracket 15 having a horizontal portion 60 that is disposed on and alongside the horizontal portion 54 of the second platform support truss 5, a downward portion 62 connected at about a right angle to and extending down from the horizontal portion 60 of the second bracket 15 and disposed alongside and adjacent with the downward portion 56 of the second platform support truss 5 and connected to the center portion 20, and a hooking portion 58 connected to the horizontal portion 60 of the second bracket 15 that wraps about the upward portion 52 of the second platform support truss 5.

There is the step of placing a platform 2 upon which a user stands on the first and second support trusses and first and second brackets and over a center portion of the removable support that is attached to and connects the first and second brackets, the first adjustable platform support truss attached to a right end frame access ladder and a second end frame access ladder of the scaffold 200; the second adjustable platform support truss attached to the right end frame access ladder and the second end frame access ladder and essentially in parallel and spaced relation with the first adjustable platform support truss.

The center portion 20 may be a metal plate 21, as shown in FIG. 4. Alternatively, as shown in FIGS. 2 and 5, the first bracket 14 and the second bracket 15 each have a tab 41 connected to the downward portion and extending from the downward portion inwards away from the upwards portion, and the center portion 20 includes an adjustable strap 22 or metal cable 77, as shown in FIGS. 2 and 5, respectively, attached to the tab 41 of the first bracket 14 and to the tab 41 of the second bracket 15.

The hooking portion 28 may have a first leg 33 connected to the horizontal portion 30 of the first bracket 14 at about a right angle disposed alongside and aligned with the upward portion 22 of the first platform support truss 1, a middle leg 34 connected to the first leg 33 at about a right angle and disposed over the upward portion 22 of the first platform support truss 1, and a second leg 35 connected to the middle leg 34 at about a right angle and disposed alongside and aligned with the upward portion 22 of the first platform support truss 1. The hooking portion 58 of the second bracket 15 has a first leg 63 connecting to the horizontal portion 60 of the second bracket 15 at about a right angle disposed alongside and aligned with the upward portion 52 of the second platform support truss 5, a middle leg 64 connected to the first leg 63 of the second bracket 15 at about a right angle and disposed over the upward portion 52 of the second platform support truss 5, and a second leg 65 connected to the middle leg 64 of the second bracket 15 at about a right angle and disposed alongside and aligned with the upward portion 52 of the second platform support truss 5. Alternatively, as shown in FIG. 6, each hooking portion 28, 58 may have a rounded middle leg.

In the operation of the invention, when erection of the original Perry style scaffold 200 is being performed and the right and left end frame access ladders of the scaffold 200 are connected to the adjustable platform support trusses but before the scaffold platform 2 is installed, the removable supports 100 will be installed over the adjustable platform support trusses. The first and second brackets of one removable support 100 will be installed directly across from each other within 6 inches from each end of the scaffold 200. Then the scaffold platform 2 will be installed over the brackets and as usual within adjustable platform support trusses. This completes the erection of the original Perry scaffold 200 or similar scaffold with the safety brackets/straps being an integral safety part of scaffold.

During use of the scaffold 200, as two workers climb up onto the scaffold platform 2 and begin walking around on the platform 2 as they are performing their work, these platforms tend to bow in the middle causing a lot of stress to the scaffold platform 2. For example, two men are working on the scaffold 200 installing a sheet of drywall 5/8 thick and 4 by 10 feet long onto a ceiling above their heads. As the two men lift drywall and try to position drywall perfectly, they constantly reposition their footing to best position themselves to perform the work, it is usually at a time like this that there is a tremendous amount of downward pressure being applied to the platform 2 surface causing the platform 2 to bow in the middle. This is usually when a weakened platform 2 can bow in the middle and allow itself to fall through the scaffold adjustable platform support trusses. This is where the brackets/strap of the removable support 100 will prevent the weakened platform 2 to fall through.

There is another benefit to using these straps: The reason these types of rolling scaffolds are so beneficial on the jobsites is they can be erected easily by one person except for the part of installing the platform 2, especially on a 10 foot long scaffold 200. The platform 2, if not set in place perfectly falls through the adjustable platform support trusses. This is not an infrequent occurrence. It is somewhat awkward trying to set the platform 2 in place and trying to not get ones fingers pinched at the same time. With the removable supports 100, a person can just lay the platform 2 over one adjustable platform support truss and let it rest on the straps, then just slide the platform 2 into place with no chance of the platform 2 falling through to ground, landing on toes.

There are several reasons why the bracket is designed with a vertical portion extending down from the horizontal portion, with this vertical portion connecting the horizontal portion with the tab. One reason is that the strap is then positioned below the underside of the platform at a minimal dimension to allow the strap to support a bowing plank when needed but not be positioned too close to the underside of the platform where the strap would then have constant friction from any slight movement of the plank. Over time, the effects of such a repeated slight movement may create damage to the strap. Another reason is that this downward or vertical portion gives the bracket additional strength when downward pressure is applied at the center of the strap caused by a bowing plank. When pressure is applied to the strap, the strap pulls down on the edge of the tab where the strap is connected, which in turn pushes the back side of the vertical portion into the surface of the vertical portion of the truss. If the vertical portion was not present and the horizontal portion of the bracket just extended straight out to the tab, the plank would have constant friction with the strap as noted above; plus when downward pressure would be applied to the strap, it would cause the horizontal portion of the bracket to teeter totter at the edge of the horizontal surface of the truss and possibly cause the hooking portion of the bracket to lift and possibly not perform as it should.

Two removable supports 100 would be applicable on a six foot long original Perry scaffold or similar scaffold of any length. If it desired to use additional supports, such as three, four or five removable supports 100, that is fine too.

As an example of some dimensions of the removable support 100, the total length is 29- 7/16 inches from the end of the first bracket 14 to the end of the second bracket 15, and the strap in the middle is 24-⅝ inches long. Each bracket is about 3 inches wide and the strap 22 is about 2 inches wide. The removable support 100 will work ideally on all original “classic” Perry scaffolds and will also work on most similar scaffolds by eliminating injuries on the construction sites caused by faulty or worn out platforms. This will also give the workers a piece of mind (safety) as they are working on these types of scaffolds. Alternatively, the brackets may be 2 inches wide instead of 3 inches wide and the strap may be 1 inch wide instead of 2 inches wide.

One of the key aspects of the removable support 100 is each bracket is formed to imitate the profile of the original Perry scaffold or similar scaffold adjustable platform support truss. Each bracket overlaps the ¾ inch high upwards portion or flange of its adjustable platform support truss. Then the 1 7/16 inch flat center or horizontal portion of the bracket rests on top of the flat area of the horizontal or center portion of the adjustable platform support truss. Then the bracket steps ½ inch lower and extends out flat for about 1 inch. This 1 inch flat area has a ¼ inch slot 73 to receive the strap 22. When the bracket overlaps the ¾ inch high upwards portion of the adjustable platform support truss, this prevents the bracket from slipping off of the adjustable platform support truss or being pulled off of the adjustable platform support truss when downward stress is applied to the strap 22. Also by forming the bracket to conform with the profile the adjustable platform support truss, this allows the bracket to fit snuggly between the adjustable platform support truss and scaffold platform eliminating any tripping hazards at the work surface of the platform 2.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1. A scaffold comprising:
a right end frame access ladder having a right rail and a left rail in spaced relation with the right rail, and a plurality of horizontals attached to the right rail and the left rail;
a left end frame access ladder having a right rail and a left rail in spaced relation with the right rail, and a plurality of horizontals attached to the right rail and left rail;
first adjustable platform support truss attached to the right end frame access ladder and the second end frame access ladder;
a second adjustable platform support truss attached to the right end frame access ladder and the second end frame access ladder and essentially in parallel and spaced relation with the first adjustable platform support truss, the first and second adjustable platform support trusses each having a horizontal portion, and upward portion connected at about a right angle to the horizontal portion and extending upward from the horizontal portion, and a downward portion connected at about a right angle with the horizontal portion and extending downward from the horizontal portion, the upward portion and the horizontal portion and the downward portion together having essentially a cross sectional shape of a Z with a surface having a Z shape;
a removable support having a first bracket, a second bracket and a center portion connected to the first and second brackets, the first bracket removably connected with the first platform support truss having a shape that conforms with the Z shape of the surface, the first bracket having a horizontal portion that is disposed on and alongside the horizontal portion of the first platform support truss, a downward portion connected at about a right angle to and extending down from the horizontal portion of the first bracket and disposed alongside and adjacent with the downward portion of the first platform support truss and connected to the center portion, and a hooking portion connected to the horizontal portion of the first bracket that wraps about the upward portion of the first platform support truss; the second bracket having a horizontal portion that is disposed on and alongside the horizontal portion of the second platform support truss, a downward portion connected at about a right angle to and extending down from the horizontal portion of the second bracket and disposed alongside and adjacent with the downward portion of the second platform support truss and connected to the center portion, and a hooking portion connected to the horizontal portion of the second bracket that wraps about the upward portion of the second platform support truss, and
a platform disposed on the first and second support trusses and first and second brackets upon which a user stands.

2. The scaffold of claim 1 wherein the center portion is a metal plate.

3. The scaffold of claim 1 wherein the first bracket and the second bracket each have a tab connected to the downward portion and extending from the downward portion inwards away from the upwards portion, and the center portion includes an adjustable strap or metal cable attached to the tab of the first bracket and to the tab of the second bracket.

4. The scaffold of claim 1 wherein the hooking portion of the first bracket has a first leg connected to the horizontal portion of the first bracket at about a right angle disposed alongside and aligned with the upward portion of the first platform support truss, a middle leg connected to the first leg at about a right angle and disposed over the upward portion of the first platform support truss, and a second leg connected to the middle leg at about a right angle and disposed alongside and aligned with the upward portion of the first platform support truss; and the hooking portion of the second bracket has a first leg connecting to the horizontal portion of the second bracket at about a right angle disposed alongside and aligned with the upward portion of the second platform support truss, a middle leg connected to the first leg of the second bracket at about a right angle and disposed over the upward portion of the second platform support truss, and a second leg connected to the middle leg of the second bracket at about a right angle and disposed alongside and aligned with the upward portion of the second platform support truss.

5. The scaffold of claim 1 wherein the hooking portion of the first bracket has a first leg connected to the horizontal portion of the first bracket at about a right angle disposed alongside and aligned with the upward portion of the first platform support truss, a rounded middle leg connected to the first leg and disposed over the upward portion of the first platform support truss, and a second leg connected to the middle leg and disposed alongside and aligned with the upward portion of the first platform support truss; and the hooking portion of the second bracket has a first leg connecting to the horizontal portion of the second bracket at about a right angle disposed alongside and aligned with the upward portion of the second platform support truss, a rounded middle leg connected to the first leg of the second bracket and disposed over the upward portion of the second platform support truss, and a second leg connected to the middle leg of the second bracket and disposed alongside and aligned with the upward portion of the second platform support truss.

6. A removable support for a scaffold, the scaffold having a right end frame access ladder having a right rail and a left rail in spaced relation with the right rail, and a plurality of horizontals attached to the right rail and the left rail; a left end frame access ladder having a right rail and a left rail in spaced relation with the right rail, and a plurality of horizontals attached to the right rail and left rail; a first adjustable platform support truss attached to the right end frame access ladder and the second end frame access ladder; and a second adjustable platform support truss attached to the right end frame access ladder and the second end frame access ladder and essentially in parallel and spaced relation with the first adjustable platform support truss, the first and second adjustable platform support trusses each having a horizontal portion, and upward portion connected at about a right angle to the horizontal portion and extending upward from the horizontal portion, and a downward portion connected at about a right angle with the horizontal portion and extending downward from the horizontal portion, the upward portion and the horizontal portion and the downward portion together having essentially a cross sectional shape of a Z with a surface having a Z shape; and a platform disposed on the first and second support truss upon which a user stands, the removable support comprising:
a first bracket;
a second bracket; and
a center portion connected to the first and second brackets, the first bracket removably connected with the first platform support truss having a shape that conforms with the Z shape of the surface, the first bracket having a horizontal portion that is disposed on and alongside the horizontal portion of the first platform support truss, a downward portion connected at about a right angle to and extending down from the horizontal portion of the first bracket and disposed alongside and adjacent with the downward portion of the first platform support truss and connected to the center portion, and a hooking portion connected to the horizontal portion of the first bracket that wraps about the upward portion of the first platform support truss; the second bracket having a horizontal portion that is disposed on and alongside the horizontal portion of the second platform support truss, a downward portion connected at about a right angle to and extending down from the horizontal portion of the second bracket and disposed alongside and adjacent with the downward portion of the second platform support truss and connected to the center portion, and a hooking portion connected to the horizontal portion of the second bracket that wraps about the upward portion of the second platform support truss, the platform disposed on the first and second brackets.

7. The support of claim 6 wherein the center portion is a metal plate.

8. The support of claim 7 wherein the first bracket and the second bracket each have a tab connected to the downward portion and extending from the downward portion inwards away from the upwards portion, and the center portion includes an adjustable strap or metal cable attached to the tab of the first bracket and to the tab of the second bracket.

9. The support of claim 7 wherein the hooking portion of the first bracket has a first leg connected to the horizontal portion of the first bracket at about a right angle disposed alongside and aligned with the upward portion of the first platform support truss, a middle leg connected to the first leg at about a right angle and disposed over the upward portion of the first platform support truss, and a second leg connected to the middle leg at about a right angle and disposed alongside and aligned with the upward portion of the first platform support truss; and the hooking portion of the second bracket has a first leg connecting to the horizontal portion of the second bracket at about a right angle disposed alongside and aligned with the upward portion of the second platform support truss, a middle leg connected to the first leg of the second bracket at about a right angle and disposed over the upward portion of the second platform support truss, and a second leg connected to the middle leg of the second bracket at about a right angle and disposed alongside and aligned with the upward portion of the second platform support truss.

10. The support of claim 7 wherein the hooking portion of the first bracket has a first leg connected to the horizontal portion of the first bracket at about a right angle disposed alongside and aligned with the upward portion of the first platform support truss, a rounded middle leg connected to the first leg and disposed over the upward portion of the first platform support truss, and a second leg connected to the middle leg and disposed alongside and aligned with the upward portion of the first platform support truss; and the hooking portion of the second bracket has a first leg connecting to the horizontal portion of the second bracket at about a right angle disposed alongside and aligned with the upward portion of the second platform support truss, a rounded middle leg connected to the first leg of the second bracket and disposed over the upward portion of the second platform support truss, and a second leg connected to the middle leg of the second bracket and disposed alongside and aligned with the upward portion of the second platform support truss.

11. A method for using a scaffold comprising the steps of:
removably connecting a first bracket of a removable support with a first adjustable platform support truss of the scaffold, the first adjustable platform support truss has a horizontal portion, an upward portion connected at about a right angle to the horizontal portion and extending upward from the horizontal portion, and a downward portion connected at about a right angle with the horizontal portion and extending downward from the horizontal portion, the upward portion and the horizontal portion and the downward portion together having essentially a cross sectional shape of a Z with a surface having a Z shape, the first bracket having a shape that conforms with the Z shape of the surface, the first bracket having a horizontal portion that is disposed on and alongside the horizontal portion of the first platform support truss, the first bracket having a downward portion connected at about a right angle to and extending down from the horizontal portion of the first bracket and disposed alongside and adjacent with the downward portion of the first platform support truss and connected to the center portion, and the first bracket having a hooking portion connected to the horizontal portion of the first bracket that wraps about the upward portion of the first platform support truss;
removably connecting a second bracket of the removable support with a second adjustable platform support truss of the scaffold, the second adjustable platform support truss has a horizontal portion, an upward portion connected at about a right angle to the horizontal portion of the second adjustable platform support truss and extending upward from the horizontal portion of the second adjustable platform support truss, and a downward portion connected at about a right angle with the horizontal portion of the second adjustable platform support truss and extending downward from the horizontal portion of the second adjustable platform support truss, the upward portion and the horizontal portion and the downward portion of the second adjustable platform support truss together having essentially a cross sectional shape of a Z with a surface having a Z shape, the second bracket having a horizontal portion that is disposed on and alongside the horizontal portion of the second platform support truss, a downward portion connected at about a right angle to and extending down from the horizontal portion of the second bracket and disposed alongside and adjacent with the downward portion of the second platform support truss and connected to the center portion, and a hooking portion connected to the horizontal portion of the second bracket that wraps about the upward portion of the second platform support truss; and
placing a platform upon which a user stands on the first and second support trusses and first and second brackets and over a center portion of the removable support that is attached to and connects the first and second brackets, the first adjustable platform support truss attached to a right end frame access ladder and a second end frame access ladder of the scaffold; the second adjustable platform support truss attached to the right end frame access ladder and the second end frame access ladder and essentially in parallel and spaced relation with the first adjustable platform support truss.

12. The method of claim 11 wherein the center portion is a metal plate.

13. The method of claim 11 wherein the first bracket and the second bracket each have a tab connected to the downward portion and extending from the downward portion inwards away from the upwards portion, and the center portion includes an adjustable strap or metal cable attached to the tab of the first bracket and to the tab of the second bracket.

14. The method of claim 11 wherein the hooking portion of the first bracket has a first leg connected to the horizontal portion of the first bracket at about a right angle disposed alongside and aligned with the upward portion of the first platform support truss, a middle leg connected to the first leg at about a right angle and disposed over the upward portion of the first platform support truss, and a second leg connected to the middle leg at about a right angle and disposed alongside and aligned with the upward portion of the first platform support truss; and the hooking portion of the second bracket has a first leg connecting to the horizontal portion of the second bracket at about a right angle disposed alongside and aligned with the upward portion of the second platform support truss, a middle leg connected to the first leg of the second bracket at about a right angle and disposed over the upward portion of the second platform support truss, and a second leg connected to the middle leg of the second bracket at about a right angle and disposed alongside and aligned with the upward portion of the second platform support truss.

15. The method of claim 11 wherein the hooking portion of the first bracket has a first leg connected to the horizontal portion of the first bracket at about a right angle disposed alongside and aligned with the upward portion of the first platform support truss, a rounded middle leg connected to the first leg and disposed over the upward portion of the first platform support truss, and a second leg connected to the middle leg and disposed alongside and aligned with the upward portion of the first platform support truss; and the hooking portion of the second bracket has a first leg connecting to the horizontal portion of the second bracket at about a right angle disposed alongside and aligned with the upward portion of the second platform support truss, a rounded middle leg connected to the first leg of the second bracket and disposed over the upward portion of the second platform support truss, and a second leg connected to the middle leg of the second bracket and disposed alongside and aligned with the upward portion of the second platform support truss.
